(19) United States
(12) Patent Application Publication
(10) Pub. No.: US 2007/0014423 A1
(43) Pub. Date: Jan. 18, 2007

(54) Behind-the-ear auditory device

(75) Inventors: Alexander L. Darbut, Edina, MN (US); Thomas Bruce Odegard, Minneapolis, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Lotus Technology, Inc.

(21) Appl. No.: 11/184,604

(22) Filed: Jul. 18, 2005

(51) Int. Cl. H04R 25/00

(52) U.S. Cl. 381/330

(57) ABSTRACT

An auditory device is disclosed. The auditory device includes a behind-the-ear element and an at least partially in-ear element. The behind-the-ear element has a shell shaped to fit behind an outer portion of an ear of a user. The shell has first and second sides that are substantially parallel to each other. The first side faces the outer portion of the ear, and the second side faces a head of the user. The behind-the-ear element also includes sound processing circuitry within the shell. The behind-the-ear element further includes an ear cushion switch operatively connected to the sound processing circuitry. The ear cushion switch is located on the first side of the shell. The at least partially in-ear element includes a microphone, acoustic pickup pillow-pad, sensors, receiver and a cushioned tip. The at least partially in-ear element can include a closed ear detachable cushioned tip and an open ear detachable cushioned tip.

### TECHNICAL FIELD

The present invention relates generally to auditory devices. More specifically, the invention relates to a behind-the-ear auditory device.

### BACKGROUND

Behind-the-ear auditory devices, such as hearing aids, headsets, or other audio monitors, are often uncomfortable to wear and difficult to adjust. These devices generally have a behind-the-ear element and an in-ear element. The behind-the-ear element contains the majority of the circuitry for such devices, including a microphone, switches, and other sound processing circuitry. The switch or switches required for adjusting the mode of the device are generally on the top edge of the element. These switches are small and difficult to operate, particularly for users who have arthritis or otherwise lack finger dexterity.

Behind-the-ear auditory devices also generally have an in-ear element that is one of two main types: it can be closed ear, which means that it completely occludes the auditory canal, or it can be open ear, which means that there is an open path laterally from the ear drum to the concha of the pinna. Both types of devices have advantages and disadvantages. Open ear devices reduce the occlusion effect, which is recognized as the hollowness of the wearer's voice or a plugged sensation that occurs when acoustic energy is trapped in the ear canal. However, open ear devices have a reduced gain available due to acoustic feedback. Conversely, closed ear devices have less acoustic feedback and higher gain possible, but increase the occlusion effect, if securely seated in the cartilaginous portion of the ear drum and not properly vented:

In both types of devices, the circuitry in the behind-the-ear element is tuned to maximize the gain from the single or dual microphones to give the best sound quality possible for that device. Because of the acoustic differences, both the open ear and closed ear auditory devices require unique tuning for that type of in-ear element and present distinct advantages and disadvantages.

Therefore, improvements are desirable.

### SUMMARY

In accordance with the present disclosure, the above and other problems are solved by the following:

In one aspect, an auditory device is disclosed. The auditory device includes a behind-the-ear element and an at least partially in-ear element. The behind-the-ear element has a shell shaped to fit behind the pinna an outer portion of an ear of a user. The shell has first and second sides that are substantially parallel to each other. The first side is parallel to faces the outer portion of the pinna, and the second side is parallel to the head of the user. The behind-the-ear element also includes sound processing circuitry within the shell. The behind-the-ear element further includes an ear cushion switch operatively connected to the sound processing circuitry. The ear cushion switch is located on the first side of the shell. The at least partially in-ear canal element includes a receiver, microphone with optional temperature and pulse oximetry-heart rate sensor elements and a cushioned tip.

According to another aspect, a configurable auditory device is disclosed. The configurable auditory device includes a behind-the-ear element and an at least partially in-ear canal element. The behind-the-ear element has a shell shaped to fit behind an outer portion of the pinna of a user. The shell has first and second sides that are substantially parallel to each other. The first side faces the outer portion of the ear, and the second side faces a head of the user. The behind-the-ear element also includes sound processing circuitry, control components, battery and additional microphones for improved listening in noisy environments within the shell. The at least partially in-ear canal element includes a receiver, microphone, acoustic pickup cushion pillow and optional sensor elements, a first detachable cushioned tip having a first auditory characteristic, and a second detachable cushioned tip having a second auditory characteristic.

According to another aspect, a method of changing a mode of an auditory device is disclosed. The method includes placing an auditory device having an ear cushion switch operatively connected to sound processing circuitry behind an ear, the ear cushion switch facing an outer portion of a pinna. The method further includes pressing the outer portion of the pinna to activate the pinna/ear cushion switch. The ear cushion switch can also be positioned on the spine of the BTE co-located with the microphone ports and trimmer or on the underside of the BTE.

According to a further aspect, a further method of changing a mode of an auditory device is disclosed. The method includes detaching a first cushioned tip having a first configuration from an at least partially in-ear canal element of an auditory device attachment options: threaded, push-on flange, and snap fit requiring a special tool to remove cushioned tip. The method further includes attaching a second cushioned tip having a second configuration to the at least partially in-ear canal element. The first configuration and the second configuration provide different acoustical characteristics.

According to another aspect, an at least partially in-ear hearing aid is disclosed. The at least partially in-ear hearing aid includes sound processing circuitry within a shell. It also includes a receiver, microphone, acoustic pickup pillow-cushions (note: one pillow cushion is for user voice cellphone pickup and a second pillow-cushion to laterally provide sufficient pressure against the cartilaginous portion of the ear canal to make the bone conduction function, and a body temperature sensor and or heart rate pulse oximetry sensing. The receiver is operatively connected to the sound processing circuitry, and resides within an at least partially in-ear canal portion of the at least partially in-ear hearing aid. The receiver is designed to generate audio signals received from the sound processing circuitry. The body temperature sensor is operatively connected to the sound processing circuitry, and resides within the at least partially in-ear portion of the at least partially in-ear hearing aid.

### BRIEF DESCRIPTION OF THE DRAWINGS

FIG. 1 is a perspective view of an auditory device, according to an embodiment of the present disclosure;

FIG. 1A is an illustration of the auditory device of FIG. 1 during use, according to an embodiment of the present disclosure;

FIG. 1B is an illustration of another view of the auditory device of FIG. 1A, according to an embodiment of the present disclosure;

FIG. 1C is an illustration of the auditory device of FIG. 1, according to an embodiment of the present disclosure;

FIG. 1D is an illustration of the auditory device of FIG. 1, according to an embodiment of the present disclosure;

FIG. 2 is a cutaway view of the auditory device of FIG. 1, according to an embodiment of the present disclosure;

FIG. 3 is an exploded view of a behind-the-ear element, according to an embodiment of the present disclosure;

FIG. 4 is a cross-section view of a behind-the-ear element, according to an embodiment of the present disclosure;

FIG. 5 is an exploded view of a microphone dampening system, according to an embodiment of the present disclosure;

FIG. 6 is a view of a connective element, according to an embodiment of the present disclosure;

FIG. 7 is a block diagram of sound processing circuitry, according to an embodiment of the present disclosure;

FIG. 8A is a functional diagram of the operation of sound processing circuitry, according to an embodiment of the present disclosure;

FIG. 8B is a functional diagram of a sound processing interrupt, according to an embodiment of the present disclosure;

FIG. 9 is a perspective view of an at least partially in-ear element, according to an embodiment of the present disclosure;

FIG. 10 is a perspective view of a cushioned tip with an open ear configuration, according to an embodiment of the present disclosure;

FIG. 11 is a perspective view of a cushioned tip with a closed ear configuration, according to an embodiment of the present disclosure;

FIG. 12 is a side view of an at least partially in-ear element according to a further embodiment of the present disclosure;

FIG. 13 is a top view of an auditory device according to another embodiment of the present disclosure;

FIG. 14 is a side view of the auditory device of FIG. 13;

FIG. 15 is another view of the auditory device of FIG. 13;

FIG. 16 is a perspective view of the auditory device of FIG. 13;

FIG. 17 is a perspective view of the auditory device of FIG. 13;

FIG. 18 is an exploded view of an auditory device according to another embodiment f the present disclosure;

FIG. 19 is an exploded view of an auditory device according to another embodiment;

FIG. 20 is a perspective view of an auditory device with an open ear configuration; and

FIG. 21 is a perspective view of an auditory device with a closed ear configuration.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

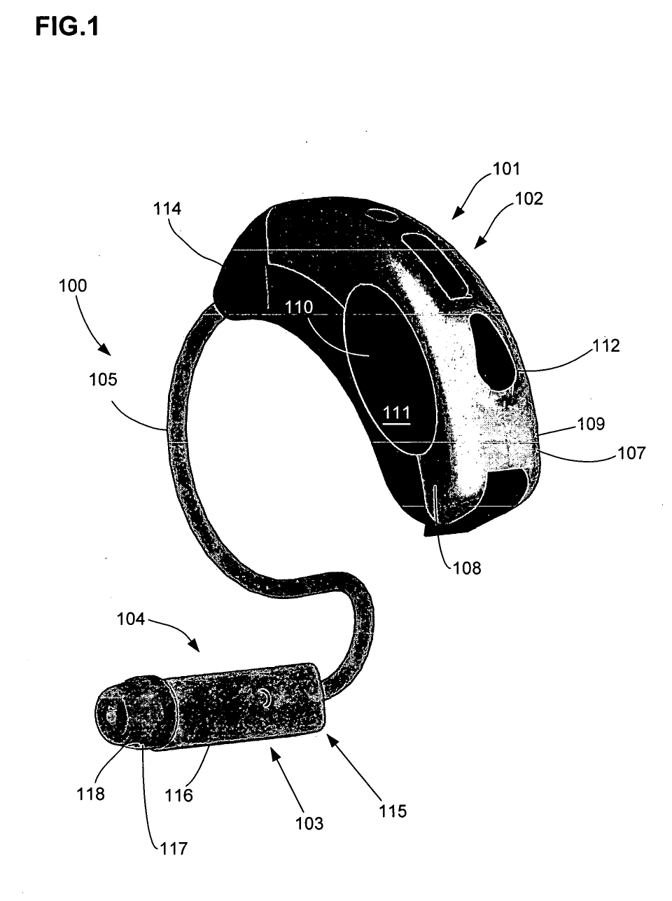

Referring now to FIGS. 1A and 1B, an auditory device 100 is shown. The auditory device 100 has a first element 101. Preferably the first element is a behind-the-ear element 102. The auditory device 100 also has a second element 103. Preferably, the second element is an in-ear canal element 104. The behind-the-ear element 102 is connected to the in-ear canal element 104 by a third element 105. Preferably, the third element 105 is a molded, flexible wire cable conduit 106. FIG. 1A illustrates the auditory device 100 during use. The ear includes an eterral ear canal 197, a concha 198, and a pinna 199. FIG. 1B further illustrates the auditory device 100 during use. The medial aspect 196 of the pinna 199 is shown.

The behind-the-ear element 102 has an outer-periphery or shell 107 shaped to fit behind a portion of the ear on the upper pinna of the user (medical aspect of the pinna). FIGS. 1A and 1B illustrate the auditory device 100 in use. The shell 107 has a first side 108 and a second side 109 (of which only the top edge is visible in FIG. 1) substantially parallel to each other, and the first side 108 facing the outer portion of the ear and the second side 109 facing a head of the user. Of course, the device 100 can be worn on either ear with the first and second sides 108, 109 reversed. The shell 108 can be formed from plastic, metal, or any other suitable material.

Preferably, the shell is waterproof or water resistant. In the embodiment shown, the shell is formed of a metal alloy and has a rubberized surface area that rests on the ear of the user. This construction provides durability while also providing a comfortable surface contacting the user's pinna/ear.

The shell 107 is sized to fit a typical user. The behind-the-ear element 102 is between 0.5 inches and 3 inches long and between 0.25 inches and 2.5 inches tall. Typically, the behind-the-ear element is 1.13 inches long and 0.83 inches tall. Devices of these dimensions are comfortable to most adult users; however, these dimensions can be varied to account for children or other users with ears smaller or larger.

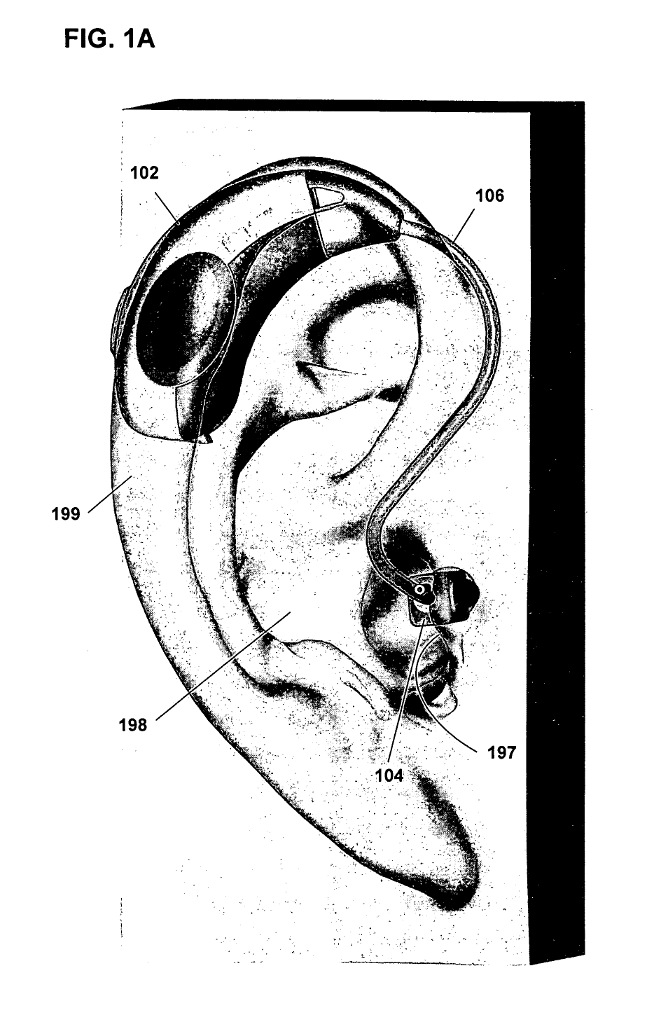

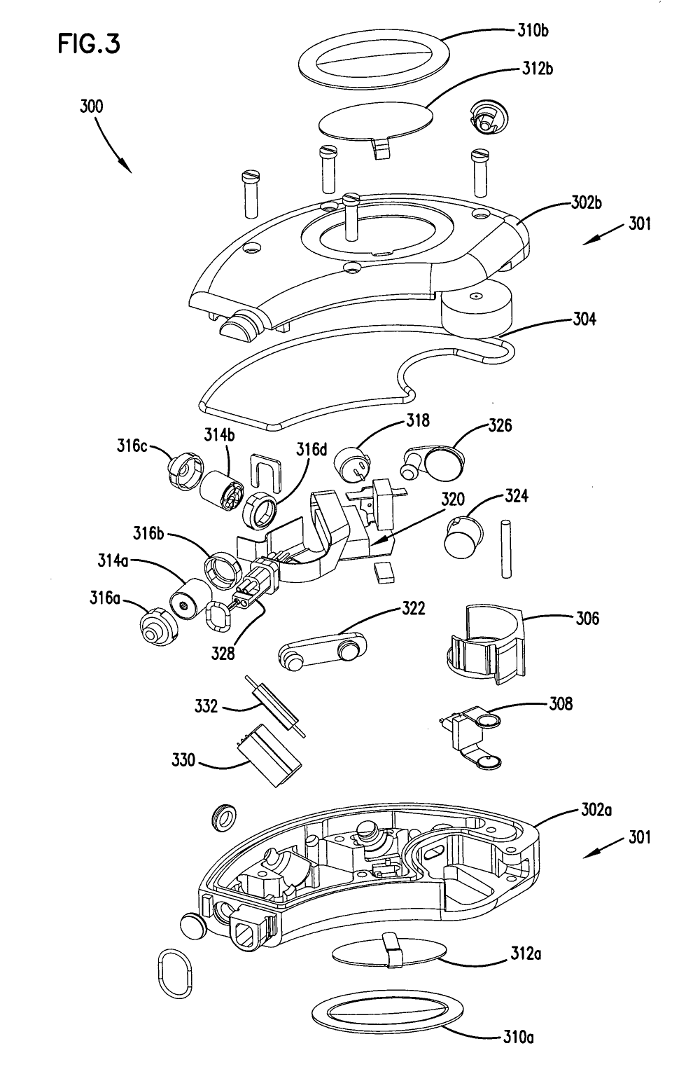

The behind-the-ear element 102 contains sound processing circuitry within the shell 108 (shown and described in connection with FIGS. 2 and 7, below). The behind-the-ear element 102 includes a switch 110, which includes an ear cushion switch 111 located on the first side 108 of the shell 107 and operatively connected to the sound processing circuitry. The ear cushion switch 111 can be, for example, a pushbutton switch, membrane switch, or other mechanical pressure-activated switch, or alternating layers of conductive rubber and insulated layers (reference the z-rubber interconnects drawings this is important because this technique has never been used as a switch. The ear cushion switch 111 can also be of other suitable switches. The switch 111 has an external surface that, in the embodiment shown, is a substantially waterproof, depressible membrane.

In another possible embodiment (not shown), the behind-the-ear element has two ear cushion switches, one each on opposite sides 108, 109 of the behind-the-ear element 102, the first ear cushion switch in the first side 108 facing the head and the second ear cushion switch in the second side 109 facing the outer portion of the ear. This allows the auditory device 100 to be worn on either a right ear or a left ear of the user while ensuring that one button is facing the outer portion of that ear.

The behind-the-ear element 102 also has an audio input/output port 112. The audio input/output port 112 can accept an audio jack connected to an external device, for example, a cellular telephone or an audio device such as a compact disk, microdrive, or flash memory music player. The audio input/output port 112 can also connect to an external device such as a computer to operate as a data input port. The port 112 can be used to reprogram the auditory device to customize the sound characteristics to the user as well as other internal options. The sound processing circuitry detects whether the audio input/output port is used as a data or audio port based on a characteristic of the signal sent to the port 112 from the external device.

The audio input/output port 112 shown in the particular embodiment represented in FIG. 1 requires a wired connection to an external device. However, other electronic connections can be implemented as the port 112 consistent with the present disclosure and can be a wireless port. For example, the port 112 can be an RF connection of any number of protocols, including 802.11a/b/g or Bluetooth.

The behind-the-ear element 102 has a connector 114 including at least four conductive elements. Two elements are generally used for unidirectional electronic communication from the behind-the-ear element 102 to the in-ear element 104 in behind-the-ear auditory devices such as the device 101 described. A connector 114 having four conductive elements enables bidirectional electronic communication between the behind-the-ear element 102 and the in-ear element 104.

Preferably, the connector 114 is covered by a strain relief material that forms a detachable connection between the behind-the-ear element 102 and the flexible conduit 106 leading to the in-ear element 101. The strain relief material can be a semi-flexible material that, when attached over the connector 114, creates a waterproof seal protecting the connector 114.

The at least partially in-ear element 104 has a first portion 115. Preferably, the first portion 115 is a receiver 116. The in-ear element 104 also has a second portion 117. Preferably, the second portion 117 is a cushioned tip 118. The cushioned tip 118 is attached to the receiver, and has at least one opening, allowing sound from the receiver 116 to pass to the inner ear.

The receiver 116 resides unoccluded in the lateral two thirds of the ear canal. FIG. 1C illustrates the receiver 116 in the ear canal. The receiver 116 accepts signals sent from the sound processing circuitry of the behind-the-ear element 102. The signals are sent through one or more of the conductive elements encased in the molded, flexible conduit 106. Preferably, the receiver 116 is an electroacoustical converter, as it converts the data signals sent from the sound processing circuitry into vibrations that are projected toward the ear drum.

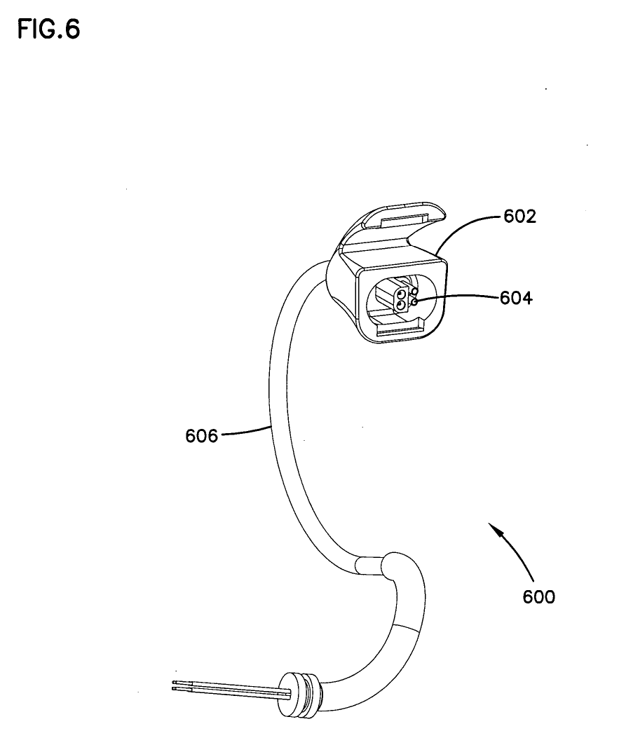

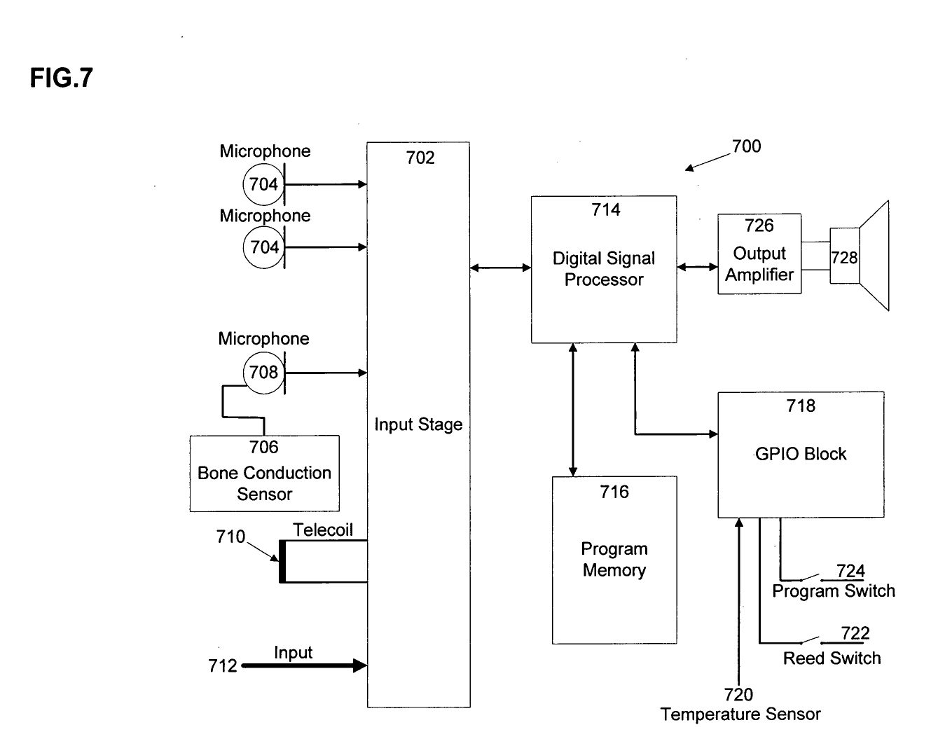

The cushioned tip 118 can be, for example, of an open ear configuration or a closed ear configuration. (see FIGS. 10 and 11 below). The cushioned tip 118 is detachable from the rest of the at least partially in-ear canal element 104. A closed ear cushioned tip fits a user in a sealed manner in the boney portion of the ear canal. FIG. 1D illustrates this embodiment. The deep fit allows a non-occluding effect while permitting increased acoustic gain. The ear canal is open lateral to the cushion tip. Alternately, an open ear cushioned tip fits a user in an unoccluded manner, and has openings from the ear canal to the outside environment. The cushioned tip 118 is removable and can be cleaned or replaced if it becomes completely occluded with earwax or other matter.

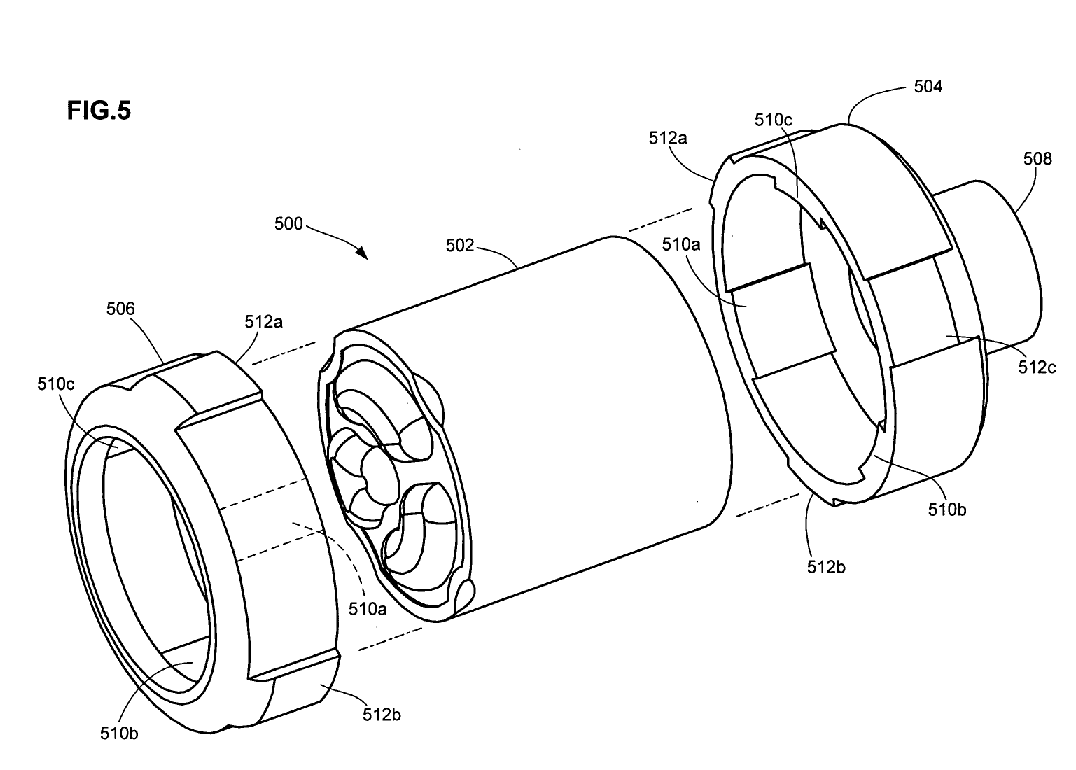

The at least partially in ear element 102 can include a microphone connected to an acoustic canal pad (see FIG. 9, below). In operation, the acoustic canal pad resides in contact with the anterior surface of the ear canal and detects vibrations caused by the user's voice. The microphone receives the acoustical energy from the acoustic canal pad through the physical connection between the two. A second pad may be required that is on the opposite side of the pickup pad because there must be adequate pressure or physical contact made between the pad and inside the ear canal. Human anatomy shows that the cross section of the ear canal will vary from a few mm to 12 mm and this variation needs to be accounted for with the transducer pick up design. The microphone transduces the signal from acoustical to electric form, sending the vibrations to the behind-the-ear element 102 in the form of electrical signals. These signals can be processed by the sound processing circuitry and relayed through the audio input/output port 112 to a cellular telephone or other communications device, eliminating the need for a boom microphone or other separate external microphone when talking on such a device.

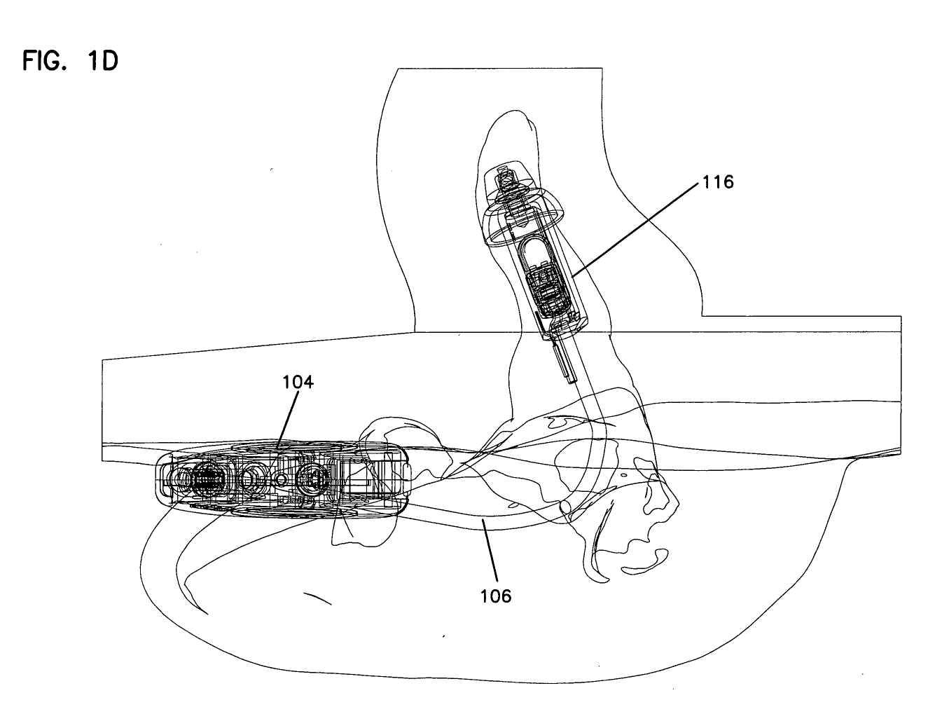

Referring now to FIG. 2, a cutaway view of an auditory device is shown. The auditory device 200 includes a behind-the-ear element 202, an at least partially in-ear element 204, and a connective conduit 206. Preferably, the behind-the-ear element 202 includes two microphones 209, 210 that detect external sounds. Preferably, each microphone 209, 210 is encased in a pair of sleeves having three internal and three external contact points to dampen interfering noise (see FIG. 5, below). Each microphone 209, 210 has one end proximate to an opening in the shell of the device 200 to detect sound external to the behind-the-ear element 204. In the embodiment shown, one microphone 209 faces forward while a second microphone faces backward 210. Sound from both microphones 209, 210 is ported to a digital signal processor (such as the bloc diagram shown in FIG. 7 below) to produce a directional effect, allowing the user of the auditory device 200 to improve the signal to noise ratio which provides better detection of signal in front of the user and attenuates sounds coming from behind.

The behind-the-ear element 202 further comprises sound processing circuitry 212. The sound processing circuitry can include, for example, any of a number of signal processing circuits designed to select, filter, and amplify sounds detected by the microphones. One specific embodiment of such circuitry is shown in FIG. 7, below.

Preferably, the sound processing circuitry 212 is programmable, and can be configured, for example, to improve the sound quality of the auditory device 200 based on the configuration of the in-ear element 204. Preferably, the sound processing circuitry includes both open and closed ear algorithms. Programmability refers to the ability of a trained technician or audiologist to change the parameters of an auditory device without remanufacture. Traditionally, programmable auditory devices used potentiometers (variable resistors), and were adjusted manually. The number of parameters that can be adjusted by potentiometers is limited by the number that can be put in a reasonably sized auditory device.

Recent programmable auditory devices can be programmed by computer. This allows many parameters to be changed, and allows users to try several listening programs, and to be able to go back to the program best for the user. These auditory devices also allow adjustment of the sound of the auditory device as the user's sound characteristic preferences change over time.

The sound processing circuitry 212 can be connected to the two microphones 209, 210 located in the behind-the-ear element 202. The microphones 209, 210 are coordinated by a digital signal processor (such as the one discussed in FIG. 7 below) to receive sound from the area surrounding the user to provide improved speech discrimination ability in the presence of competing noise.

A connector 214 is operatively connected to the sound processing circuitry 212. The connector 214 allows attachment and detachment of the matching connective conduit 206 connecting the behind-the-ear element 202 to the in-ear element 204. The connective conduit 206 has a strain relief device 216 on the portion of the conduit 206 that connects to the behind-the-ear element 202, where the strain relief device 216 matches the shape of the behind-the-ear element 202 surrounding the connector 214 to create a substantially waterproof seal covering the connector 214 within.

Preferably, the behind-the-ear element 202 includes an audio input/output port 218 and an ear cushion switch 220. The audio input/output port 218 is connected to the sound processing circuitry 212, and can be used to send audio information to the auditory device 200 or to receive audio information from the auditory device 200. The audio input/output port 218 can also be used as a data port, and can be used to program or adjust the properties of the sound processing circuitry 212. In this function, the port 218 can be used, for example, to alter an amount of amplification or filtering settings of the sound processing circuitry 212. The operation of the audio input/output port is discussed in greater detail in FIG. 7, below, in conjunction with the sound processing circuitry 212.

The ear cushion switch 220 is operatively connected to the sound processing circuitry 212. The ear cushion switch 220 can be used to activate or deactivate the auditory device 200. The ear cushion switch 220 can also be used to change one or more characteristics of the sound processing circuitry 212, such as volume or mode of operation.

The location and ease of use of the ear cushion switch 220 enable a technique of changing a mode of an auditory device, including placing the auditory device behind an ear such that an ear cushion switch faces the ear, and pressing the ear to activate the ear cushion switch. The ear cushion switch 220, operatively connected to sound processing circuitry, changes a mode of the auditory device 200.

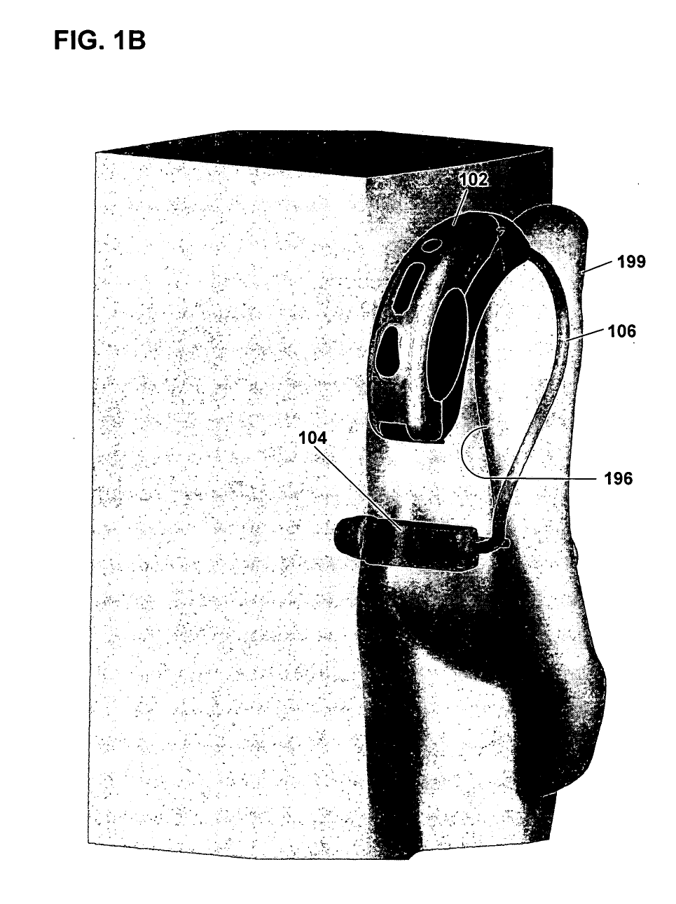

Referring now to FIG. 3, an exploded view of a behind-the-ear element 300 is shown according to a specific embodiment of the present disclosure. The behind the ear element 300 includes a shell 301. The shell 301 can be constructed of two shell sections 302a, 302b. The shell sections 302a, 302b can be fastened together using screws, adhesive, or other suitable fastening means. The shell sections 302a, 302b can be made of metal, plastic, or other rigid, machinable material. Of course any suitable material can be used. A rubberized O-ring 304 can be placed at the junction of shell sections 302a, 302b to ensure a substantially waterproof joint. Preferably, a battery door 306 is incorporated into the shell 301 and is sized to hold a standard hearing aid battery. A contact block 308 is located within the shell 301 and provides the electrical contact between a hearing aid battery and the rest of the elements in the behind-the-ear element 300.

Ear cushion switches 310a, 310b are found on each shell section 302a, 302b, respectively, such that while the behind-the-ear element 300 is worn by a user, one ear cushion switch 310a faces a head and the other ear cushion switch 310b faces the outer portion of the pinna/ear of the user. Immediately internal to each ear cushion switch 310a, 310b are trace circuitry pads 312a, 312b, respectively. Either ear cushion switch 310a, 310b can be depressed, making contact with the trace circuitry pad 312a, 312b proximately located to each ear cushion switch 310a, 310b, respectively. An internal side of each ear cushion switch 310a, 310b is conductive. Positive and negative traces on the pads 312a, 312b can be shorted together by contact with the internal side of the ear cushion switch 310a, 310b, respectively, thus causing a switching moment to occur.

A first microphone 314a and a second microphone 314b are located within the shell 301. The first and second microphones 314a, 314b are partially surrounded by dampening elements 316a-d to prevent unwanted vibration (see FIG. 5, below).

A trimmer 318 is located within the shell 302a. The trimmer 318 is operatively connected to internal circuitry 320. The internal circuitry includes, for example, a digital signal processor and program memory (see FIG. 7, below). The trimmer 318 allows adjustment of the output of the behind-the-ear element 300. The trimmer 318 is located adjacent to an access opening in the shell 301 to allow for such adjustment. A plug 322 can be included to fill such an opening in the shell 301 that can be necessary to access and adjust the trimmer 318.

A socket 324 and socket cover 326 provide a substantially waterproof access point to internal circuitry that can be used, for example, to connect an audio input/output port.

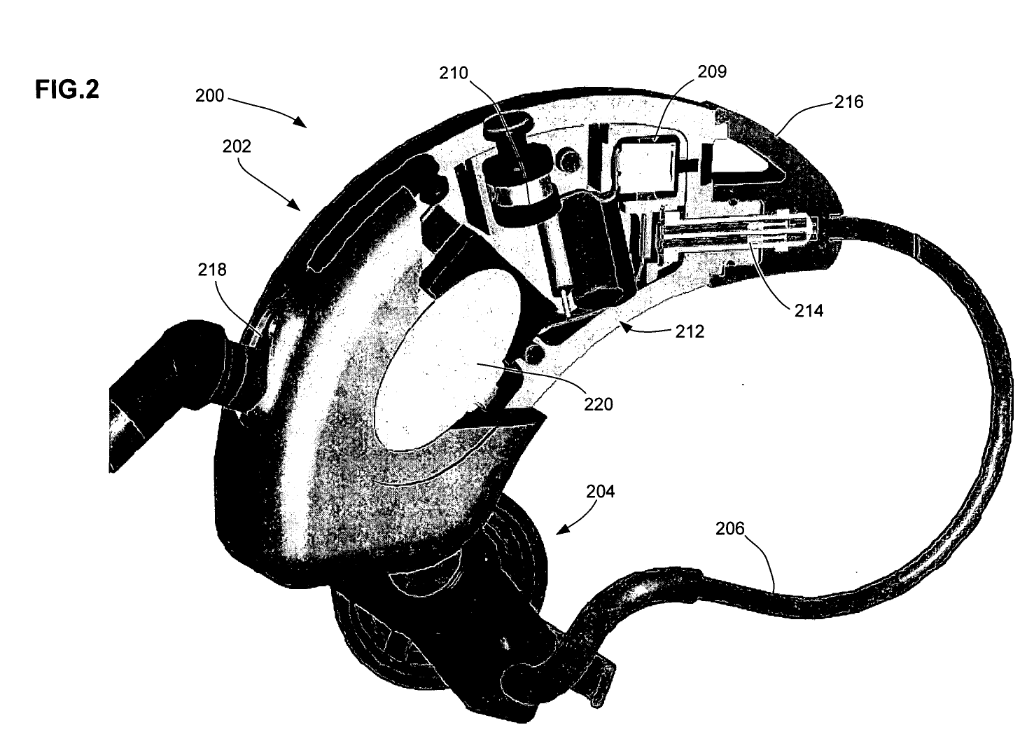

A connector 328 is incorporated into the shell 301 such that it faces forward when the behind-the-ear element 300 is worn by a user. The connector 328 includes at least four connective elements, and can be used, for example, to connect the behind-the-ear element 302 to a connective conduit such as the one shown in FIG. 6.

A telecoil 330 is included in the behind-the-ear element 300. Preferably, the telecoil 330 is a small, tightly-wrapped induction coil that, when activated, picks up the voice signal from the electromagnetic field that leaks from compatible telephones. Many telephones emit a low-level electrical signal detectable by such a telecoil 330 such as those commonly found in hearing aids. A telephone that is telecoil-compatible has an internal feature that allows the use of telephone-compatible auditory devices. Federal rules require that phones produce a magnetic field of sufficient strength and quality to permit coupling with auditory devices that contain a telecoil 330. Hence, users of telecoil-equipped auditory devices can communicate over the telephone without feedback or amplification of unwanted background noise. The telecoil 330 can be placed, for example, in the behind-the-ear element 300.

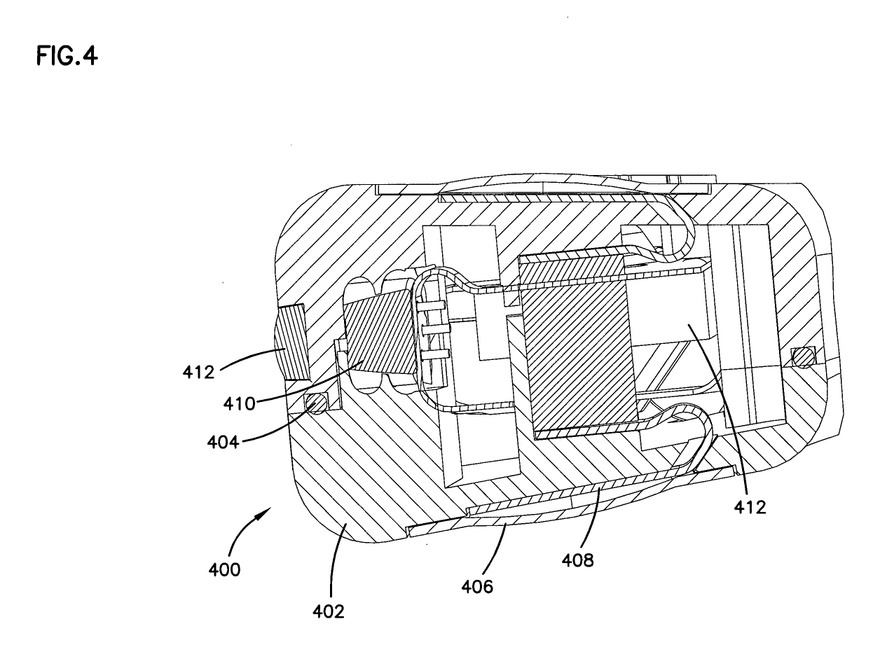

A reed switch 332 is incorporated in the behind-the-ear element 300. The reed switch 332 is activated upon detection of the magnetic field provided by a telecoil-enabled telephone. The reed switch 332 provides an interrupt switch that remains tripped when a telecoil-enabled telephone is detected as in use by the user of the auditory device 300. The reed switch 332 provides a continuous switch during the time the telecoil-enabled telephone is in use, and allows the internal circuitry 320 to operate in the correct telecoil-enabling mode during that time. (See, for example, the discussion of the telephone interrupt mode in FIG. 8B, below).

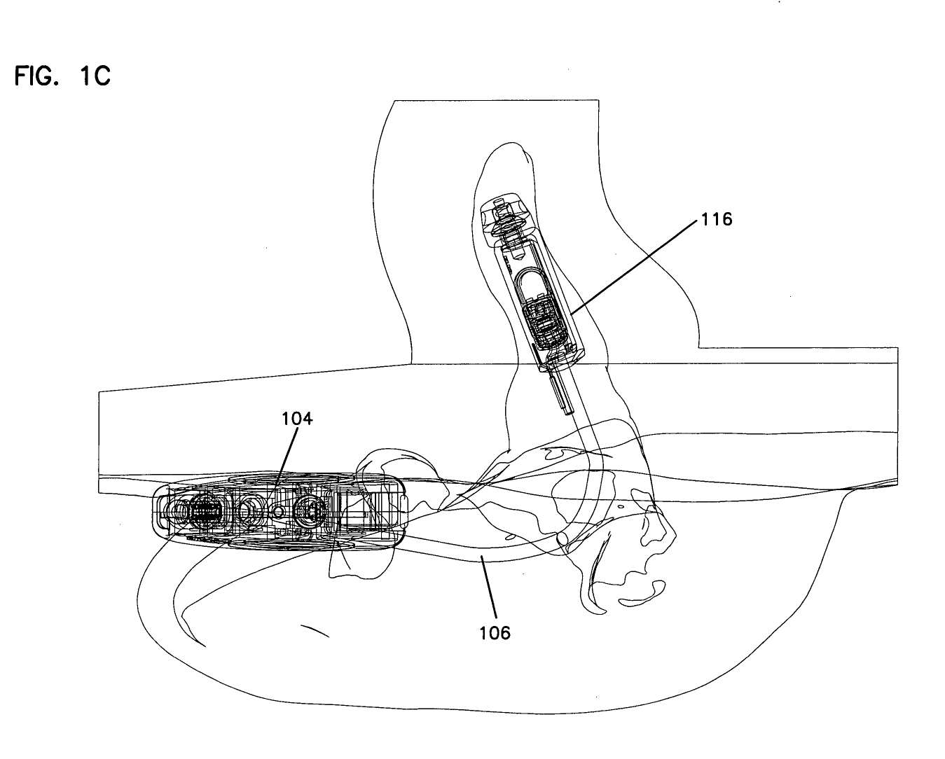

Referring now to FIG. 4, a cross-section view of a behind-the-ear element 400 is shown according to a specific embodiment of the present disclosure. The behind-the-ear element 400 includes a shell 402 that can be one or more pieces. In the embodiment shown, two pieces of the shell 402 are connected and a rubberized o-ring 404 provides waterproofing of the seal between the portions of the shell 402. The shell 402 is shaped to fit behind an ear, with the bottom portion slightly narrower than the top edge to increase comfort to a user.

The sides of the shell 402 taper slightly, but are substantially parallel. There is an ear cushion switch 406 on one or both sides of the shell. The ear cushion switch 406 covers a trace circuitry pad 408. The ear cushion switch is flexible, and can be depressed so that it makes contact with the trace circuitry pad 408. The internal side of the ear cushion switch 406 can be conductive, and can short positive and negative traces together on the trace circuitry pad 408.

A trimmer 410 resides below a removable plug 412, and the trimmer 410 can be used to adjust one or more settings of the behind-the-ear element 400. For example, the trimmer 410 can be used to adjust the amplitude of electrical signals sent by the behind-the-ear element 400. The trimmer 410 is connected to internal circuitry 412.

Referring now to FIG. 5, an exploded view of a vibration dampening system 500 is shown. The system 500 preferably includes a microphone 502 and a first dampening element 504. The system 500 can also include a second dampening element 506. The microphone 502 detects sound waves and transduces them into electrical signals. Often if the microphone 502 is in direct contact with other rigid elements, any movement of the other rigid elements caused by body acoustics or other non-sound vibration can be transferred through contact and detected by the microphone 502. This vibration potentially will create an interfering signal that can distort the detected sound waves and negatively affect the transduced electrical signal.

The dampening elements 504, 506 are made from a dampening material such as a silicone, soft plastic, rubber, or other suitable material. The first dampening element 504 has a port 508 providing an opening so that the microphone 502 can detect sound waves in the surrounding air. When used in an auditory device such as a hearing aid, the port 508 generally faces an opening in the shell of a behind-the-ear element (as seen in FIG. 2, above). Both elements 504, 506 have internal prongs 510a-c offset from external prongs 512a-c. The combination of the offset prongs 510, 512 and the dampening material insulates the microphone 502 from unwanted vibration.

Referring now to FIG. 6, a view of a connective conduit 600 is shown. The connective conduit 600 includes a strain relief device 602, a connector 604, and a wire, or conduit, 606. The strain relief 602 is shaped to form a substantially waterproof junction with a behind-the-ear element of an auditory device, such as that disclosed in FIGS. 1-4 above.

The connector 604 is surrounded by the strain relief 602. The connector 604 matches a connector on a behind-the-ear element of an auditory device, such as the one disclosed in FIGS. 1-4 above. Preferably, the connector 604 includes four connective elements, allowing for bidirectional communication of electric signals along the connective conduit 600.

The wire 606 is connected to the connector 604, and is molded into the strain relief 602. Preferably, the wire 606 includes four conductive elements corresponding to the four conductive elements of the connector 604. The wire 606 can be made of conductive elements of any material such as copper or other suitable conductive material. The conductive elements are shielded and surrounded by any molded, flexible conduit, such as a semi-rigid plastic.

Referring now to FIG. 7, a block diagram of an example sound processing circuitry 700 is shown. The sound processing circuitry 700 includes an input stage 702. The input stage 702 receives input signals from one or more input sources, and can convert analog signals to digital signals for usage by other aspects of the sound processing circuitry 700. Specifically, the input stage 702 can receive input signals from one or more microphones 704. The microphones 704 can, for example, be a pair of microphones mounted within a behind-the-ear element of an auditory device. These microphones 704 can be positioned within the behind-the-ear element, for example, to detect sounds from forward and backward of the behind-the-ear element.

The input stage 702 can also receive input signals from a bone conduction sensor 706 connected to a microphone 708. The bone conduction sensor 706 can be, for example, a flexible membrane positioned on an at least partially in-ear element so that it contacts the cartilaginous portion of the ear canal, connected to a rigid base. The bone conduction sensor 706 detects vibration of the bony portion of the ear canal caused by the user's speech.

The bone conduction sensor 706 can have an acoustic port connecting it to the microphone 708 so that the sensor 706 amplifies and routes the detected vibration to the microphone 708. The bone conduction sensor 706 acts similarly to a stethoscope in this way, and the microphone detects and converts the amplified acoustic signals to electrical signals to be sent, for example, to other sound processing circuitry in the behind-the-ear element.

Alternatively, the in the ear canal bone conduction can be replaced and positioned on the BTE as another configuration where the ear cushion switches are located. The in the ear canal microphone is then used to strictly for listening and a snorkel tube is extended outside the ear canal for pick-up. Then there are three microphones for an array pickup an listening-one in the receiver ear tip module and two on the BTE. Using Digital Signal processing this will make the hearing aid to function like a microphone array providing signal to noise improvements much greater than 5 dB typically achieved with only directional microphones. Directional microphones is defined as unidirectional microphone polar response with greater sensitivity to sound in one direction and blocking unwanted noise that may be behind the listener/user. Two omni microphones used in the BTE are combined in the DSP processor to give a special cardioid, super cardioid, or hyper-cardioid response for improved signal to noise ratio. The DSP processor can be configured to make use of all three microphones (two on BTE and one in the RX module to provide a very narrow beam of listening less than 30 degrees.

The bone conduction sensor 706 can be used to detect external sounds as well. The microphone 708 can be used with two other microphones, for example, microphones 704, as can be found in a behind-the-ear element of an auditory device to create a three-microphone array of input sources such that the sound processing circuitry 700 can process external sound with an improved signal-to-noise ratio and directivity or localization, than is possible using two microphones. Signal-to-noise ratio is an engineering term for the ratio between the magnitude of a signal (meaningful information) and the magnitude of background noise. Directivity refers to the ability of the user to determine the direction from which a sound comes from. By orienting multiple microphones in varying directions and using microphones that are more sensitive to sounds detected from a specific direction, the sound processing circuitry 700 can create a sound that simulates to a user the direction of the source of the sound.

The input stage 702 can further receive input signals from a telecoil 71Q. The telecoil 710 can be placed, for example, in the behind-the-ear element of an auditory device. The telecoil 710 amplifies electromagnetic signals emitted by equipped telephones, allowing an auditory device to assist a user in hearing a telephone conversation by minimizing interference and amplifying the desired output of the telephone. For usage with equipped telephones, telecoil amplification can be preferable to acoustic detection and amplification because, for example, it allows filtering of acoustic noise.

The input stage 702 can also receive input signals from an input port 712. The input port 712 can be a data jack, wireless communication protocol, or any other audio input/output port. The input stage 702 detects the type of device connected to the input port 712. For example, the input stage 702 can detect that the device is a cellular telephone or other communications device. The input stage 702 transmits the input signals to the rest of the sound processing circuitry 700 for subsequent filtering and/or amplification as discussed below.

Alternately, the input stage 702 can detect that the device connected to the input port 712 is a programming device. The input stage 702 could then transmit programming commands to various other portions of the sound processing circuitry (as described below).

The input stage 702 is operatively connected to a digital signal processor 714. The digital signal processor 714 is capable of performing a wide variety of functions, including gain processing, feedback reduction, noise reduction, speech enhancement, directionality control, and signal generation among other things. As such, the digital signal processor 714 executes the major sound processing steps required by a digital auditory device such as those discussed herein.

The digital signal processor 714 statistically analyses signals to automatically regulate sound channels to maximize the user's listening experience. The system compensates in each of the channels for the differences in loudness perception, known as “recruitment,” experienced by most hearing impaired users.

This loudness mapping involves a large number of compressors and varying time windows to avoid any sudden audible changes or distortion. After the signal processing is complete, the circuits convert the multibit data stream into a single pulse, direction-coded (+ or −) signal that is presented directly to the output transducer. Often noise frequencies are above a specific frequency and are ignored during output.

Regarding gain processing, the digital signal processor 714 can include input signal-specific band dependence, a numbers of channels, and kneepoints with lower compression thresholds than in an analog auditory device. Hence, inclusion of the digital signal processor 714 can lead to improved audibility with less clinician effort. The digital signal processor 714 can also be used to expand the digital signals representing sounds. This expansion can lead to greater user satisfaction by reducing the intensity of low-level environmental sounds and microphone noise.

Regarding feedback reduction, the digital signal processor 714 can use a feedback cancellation system or notch-filtering algorithm to reduce or eliminate unwanted feedback that can occur occasionally due to jaw movement or close proximity to objects.

Regarding noise reduction, the digital signal processor 714 can reduce gain in low frequencies or specific frequency bands when steady state signals are detected, indicating that such signals are noise. Such noise reduction can reduce the annoyance of the user of an auditory device and can potentially improve speech recognition, particularly in conjunction with complimentary processing of directional microphone information.

Regarding speech enhancement, the digital signal processor 714 can increase the relative intensity of some segments of speech based either on temporal or spectral content.

Regarding directionality control, the digital signal processor 714 can be used in conjunction with multiple microphones, as is shown above. The digital signal processor 714 is used to calibrate microphones, control the shape of the directional pattern, automatically switch between directional and omnidirectional modes, and through expansion, reduce additional circuit noise generated by the directional microphones. This allows a user to perceive the direction from which a sound can be coming from while not providing multiple sound feedback paths causing an echo effect from the auditory device. With respect to directionality, the digital signal processor can accept inputs from two or more microphones 704 through the input stage. These microphones can include a microphone 708 connected to a bone conduction sensor 706. Usage of an additional microphone oriented in a third direction such as microphone 708 when compared to the other directional microphones 704 can improve the signal-to-noise ratio and the directionality of the sound processing, improving a user's overall hearing experience.

Regarding signal generation, the digital signal processor 714, because of its fundamental nature, can generate and process sound signals. Loudness growth and specific spectral sound fitting can be achieved by this use. Signal generation and spectral sound fitting assists hearing-impaired users of such an auditory device, because often these users have certain spectra of sound that they have difficulty detecting. The digital signal processor 714 can be customized to amplify those certain spectra to customize the sound processing for that specific user.

Preferably, the digital signal processor 714 is operatively connected to a program memory 716. The program memory 716 can consist of read-only memory, random access memory, flash memory, other compact memory such as an EEPROM or other suitable memory. A portion of the program memory 716 allows for permanent storage of programmed settings (such as in EEPROM or flash memory) so that the auditory device can retain those program settings when the auditory device is powered off, such as when the battery is being changed. A portion of the program memory 716 must also be read/write memory such as RAM or flash memory, allowing the digital signal processor 714 to store intermediate computations as needed for digital signal processing.

The digital signal processor 714 can load stored messages from the program memory 716 and output messages to the user of the auditory device. In this way, voice messages can be delivered from the auditory device to the user. These voice messages can, for example, relate to the current mode of the device or other parameters monitored by the device.

The digital signal processor 714 is operatively connected to a general purpose input/output block 718. The general purpose input/output block 718 acts as an input controller for interrupt-driven or polled input ports. Preferably, the general purpose input/output block 718 connects to a body temperature sensor 720, heart rate-pulse oximetry sensors, a reed switch 722, and a program switch 724.

The body temperature sensor 720 resides in the at least partially in-ear element, and can detect whether, for example, the user has a fever. The temperature sensor 720 is connected to the general purpose input/output block 718, which sends information to the digital signal processor 714. The digital signal processor 714 can then be used to give verbal readings of the user's current temperature to the user through the receiver placed in the patient's ear (for example the receiver described in FIG. 9, below).

The reed switch 722 provides an interrupt switch connected to the general purpose input/output block 718, and activates when a telecoil-enabled telephone is detected as in use by the user of the auditory device. The reed switch 722 provides a continuous switch during the time the telecoil-enabled telephone is in use, allowing the auditory device to remain in one interrupt-driven mode (See, for example, telephone interrupt mode in FIG. 8B, below).

The program switch 724 allows the user to manually change the operation of the auditory device. When depressed manually, the program switch 724 sends a signal to the general purpose input/output block 718 that the user would like to change the mode of operation of the auditory device. This information is sent to the digital signal processor 714 that changes mode according to its operational flow. A possible operational flow is described below in connection with FIGS. 8A-8B. The program switch 724 can be, for example, an ear cushion switch mounted on the auditory device such as the one described above in FIGS. 2-3.

Preferably, the digital signal processor 714 is operatively connected to an output amplifier 726. The output amplifier 726 receives signals from the digital signal processor and increases or decreases the volume represented by the signal. The output amplifier can be embodied as a trimmer that is manually adjustable. The output amplifier 726 is connected to a speaker 728. The speaker 728 generates audible sound based on the electrical signals it is sent from the output amplifier 726, which are directed toward the user's eardrum. The speaker 728 can be, for example, a receiver placed in a user's ear.

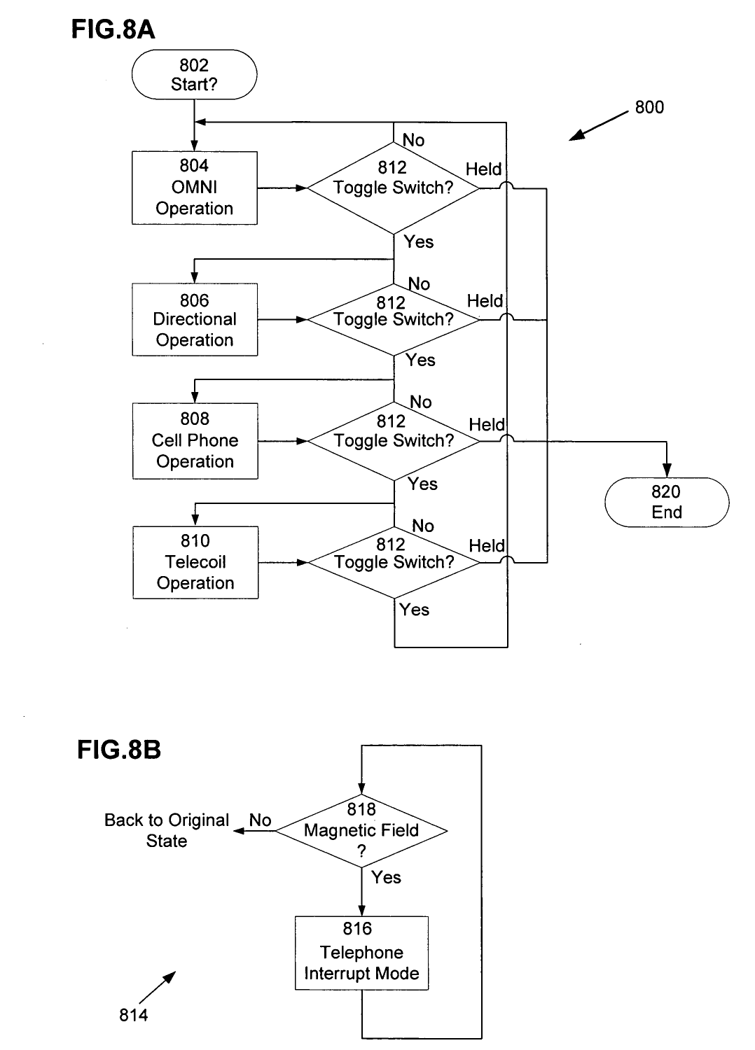

Additional input or other sensing elements can be incorporated as inputs into either the input stage 702 or the general purpose input/output block 718. For example, a heart rate monitor such as the one disclosed in FIG. 12 can be incorporated as an input into the general purpose input/output block 718. Other similar sensing elements can also be so incorporated.

Referring now to FIG. 8A, a functional diagram of the operation of the sound processing circuitry 800 is shown. This sound processing circuitry is included in an auditory device, such as a hearing aid. The operation 800 starts with a begin operation 802. This can occur, for example, when the sound processing circuitry is activated, as in when an auditory device is turned on.

After the begin operation 802, the sound processing circuitry 800 includes four modes in which it can function. The sound processing circuitry 800 can function in an omnidirectional mode 804. In this mode, the sound processing circuitry 800, including a digital signal processor such as the one described above in FIG. 7, only refers to one microphone present in an auditory device. The sound processing circuitry sends an indication to a user of an auditory device that the device is currently in the omnidirectional mode 804. This, for example, can be done by a verbal command output to a receiver on the auditory device from program memory. In the omnidirectional mode 804, processed electrical signals are sent to the receiver, for example the speaker shown in FIG. 7. The digital signal processor is actively reducing the noise levels detected by the microphone.

A directional mode 806 provides directional sound response to the user, suppressing acoustic energy from behind the user thus improving signal to noise ratio for the user. The digital signal processor can coordinate multiple microphones facing different directions. The sound processing circuitry sends an indication to a user of an auditory device that the device is currently in the directional mode 806. This, for example, can be done by a verbal command output to a receiver on the auditory device from program memory. The directional mode 806 accepts signals from multiple microphones, which are treated to create a cardioid polar response, with higher sensitivity to sounds detected forward of a user. In the directional mode 806, processed electrical signals are sent to the receiver. The digital signal processor is actively reducing the noise levels detected by the microphone.

A cell phone operation mode 808 provides two-way communication to an external communications device, such as a cellular telephone. This is particularly useful because often users of auditory devices have difficulty in simultaneous use of a cellular telephone and an auditory device. The sound processing circuitry sends an indication to a user of auditory device that the device is currently in the cell phone mode 808. This, for example, can be done by a command output to a receiver on the auditory device from program memory. A wired or wireless communications link is established from the communications device to the auditory device, providing audio information from and to the communications device. At least one microphone in the auditory device remains active, but external sound detected by the microphone is mixed with the audio input from the communications device by the digital signal processor. The external sound is mixed at a lower volume than the input received from the communications device so that a user can continue to hear both the conversation on the communications device and external sounds. This combined signal is sent to the receiver.

The cell phone operation mode 808 also includes activation of a microphone located near the cartilaginous portion of the user's ear canal such that the microphone detects ear canal vibrations sensed by a “bone conduction” sensor. The digital signal processor accepts (through the input stage shown in FIG. 7) input from the microphone. This input is an electrical representation of the speech of the user. The digital signal processor applies a noise reduction algorithm to the signal to compensate for body transfer loss. The resulting signal is output to the communications device through the communications link, rather than to the receiver.

A telecoil mode 810 allows the auditory device to assist a user in a magnetic loop equipped audition room such as a school class, a conference room, a church etc. The sound processing circuitry sends an indication to a user of auditory device that the device is currently in the telecoil mode 810. This, for example, can be done by a verbal command output to a receiver on the auditory device from program memory. While in telecoil mode 810, the auditory device can receive magnetic signals from a magnetic loop. These signals are a representation of the sound that normal people would hear broadcasted by a speaker. When in telecoil mode 810, the telecoil in a behind-the-ear element of the auditory device is active. The digital signal processor applies a noise reduction algorithm to the signal to compensate for external interference and feedback. The resulting signal is output to the receiver.

A toggle switch 812 allows the user to switch between the various modes configured for the sound processing circuitry 800. The switch 812 can be, for example, an ear cushion switch on the side of a behind-the-ear element of the auditory device.

Referring now to FIG. 8B, a functional diagram of a sound processing interrupt 814 is shown according to an embodiment of the present disclosure. A telephone interrupt mode 816 is activated separately from the toggle switch 812, and interrupts the operation of any mode currently active within the auditory device. An interrupt 818 signals that a magnetic field from a telecoil-enabled telephone is detected near the auditory device. The sound processing circuitry sends an indication to a user of an auditory device that the device is currently in the telephone interrupt mode 816. This, for example, can be done by a verbal command output to a receiver on the auditory device from program memory. While in telephone interrupt mode 816, the auditory device receives magnetic signals from a telecoil-enabled telephone. These signals are a representation of the sound emanating from a speaker within a handset of the telecoil-enabled telephone. When in telephone interrupt mode 816, the telecoil in a behind-the-ear element of the auditory device is active. The digital signal processor applies a noise reduction algorithm to the signal to compensate for external interference and feedback. The resulting signal is output to the receiver. When the telecoil-enabled telephone is moved away from the auditory device, the interrupt 818 is removed and one of the non-interrupt operation modes (such as those listed above) is resumed.

An end operation 820 suspends operation of the sound processing circuitry 800 within the auditory device. This can occur, for example, when the auditory device is deactivated or turned off based on a user holding in the toggle switch for a prolonged time.

Although FIGS. 8A and 8B show a particular order of modes, any ordering of modes could be implemented consistent with the present disclosure. Further, additional modes can be added that apply to specific functionality of the auditory device. The modes shown herein are in no way intended to limit the scope of the invention, as a wide variety of alternative implementations of program control can be implemented without departing from the spirit and scope of the disclosure.

Referring now to FIG. 9, a perspective view of an at least partially in-ear element 900 is shown. The at least partially in-ear element 900 includes a receiver 902, a microphone 904, and an acoustic canal pad 906. The at least partially in-ear element 900 further includes a cushioned tip 908, additional examples of which are shown in FIGS. 10 and 11. Preferably, the receiver 902 is electrically connected to a behind-the-ear portion of an auditory device by a pair of conductive elements that can, for example, be part of a connective conduit as shown in FIG. 6. The receiver 902 converts the electric signals to acoustic signals and emits the acoustic signals as sound appropriately.

When a user speaks, their cartilaginous portion of their ear canal is set into vibration. The acoustic canal pad 906 resides in the ear canal against the jawbone or skull to detect these vibrations. The acoustic canal pad 906 has a flexible contact membrane and a rigid base that amplify and route acoustic signals caused by the vibration to the microphone 904.

The microphone 904 is acoustically connected to the acoustic canal pad 906. The pad 906 transfers these vibrations to the microphone 904, which transduces these signals to electric signals. The microphone 904 is electrically connected to a behind-the-ear portion of an auditory device by a pair of conductive elements that can, for example, be part of a connective conduit as shown in FIG. 6. So, ear canal vibration can be detected and transduced to produce an electrical signal representative of a user's speech.

Referring to FIG. 10, a cushioned tip 1000 with an open ear configuration is shown. The cushioned tip 1000 has an output port 1002. The output port directs sound output from a receiver such as the one described above in conjunction with FIG. 9.

The cushioned tip 1000 is substantially cylindrical. The cushioned tip 1000 can be manufactured in a variety of sizes; typical configurations have an outside diameter of 0.19 inches, and a length of 0.015 inches. The cushioned tip 1000 can also have a portion of the leading edge formed at an angle to allow for easier and more comfortable insertion of an at least partially in-ear element into an ear canal of a user. In the tip 1000 shown, a leading radial edge of the tip 1000 has a 28 degree angle. Alternately, a rounded leading radial edge or other angles can be used.

An internal area of the cushioned tip 1000 is sized and formed to fit an output port of a receiver such as the one shown and described in conjunction with FIG. 9.

The cushioned tip 1000 has at least one opening 1004 transverse to and intersecting the output port 1002. The opening 1004 allows air intake necessary for sound output to occur through the port 1002 without unwanted feedback effects caused by interfering airflow.

The cushioned tip 1000 is sized and shaped so that it does not completely occlude the inner ear, allowing an air path from concha to the eardrum of the user. (See FIG. 1C.) This avoided occlusion reduces or eliminates the hollow sound of the user's voice when in an auditory device is used such as is described herein.

The cushioned tip 1000 is detachable, and slides over an output port of a receiver, such as the one shown above in FIG. 9. An appropriate cushioned tip can be installed on an at least partially in-ear element such as the one shown in FIG. 9 so as to comfortably fit a user's ear and effectively focus sound toward the user's eardrum.

Referring now to FIG. 11, a cushioned tip 1100 with a closed ear configuration is shown. The cushioned tip 1100 includes a leading portion formed of size and shape similar to that shown in FIG. 10.

The cushioned tip 1100 has an output port 1102. The output port directs sound output from a receiver such as the one described above in conjunction with FIG. 9.

The cushioned tip 1100 is substantially bell-shaped. The cushioned tip 1100 can be manufactured in a variety of sizes; typical configurations have an outside diameter of 0.315 inches to 0.472 inches, and a length of 0.252 to 0.312 inches. The cushioned tip 1100 can also have a portion of the leading edge formed at an angle to allow for easier and more comfortable insertion of an at least partially in-ear element into an ear canal of a user. In the tip 1100 shown, a leading radial edge has a 28 degree angle. Alternately, a rounded leading radial edge or other angles can be used.

An internal area of the cushioned tip 1100 is sized and formed to fit an output port of a receiver such as the one shown and described in conjunction with FIG. 9.

The cushioned tip 1100 has at least one opening 1104 transverse to and intersecting the output port 1102. The opening 1104 allows air intake necessary for sound output to occur through the port 1102 without unwanted whistling effects caused by interfering airflow.

The cushioned tip 1100 is sized and shaped so that it completely occludes the boney portion of the external ear canal. (See FIG. 1D.) The occlusion can be custom fitted for each particular user by selecting a larger or smaller tip 1100. This occlusion allows for increased gain in audio amplification of an auditory device such as is described herein. Since the cushioned tip is seated in the boney portion of the ear canal acoustic energy lateral to the tips is vented which prevents the occlusion effect.

The cushioned tip 1100 is detachable, and slides over an output port of a receiver, such as the one shown above in FIG. 9. An appropriate cushioned tip can be installed on an at least partially in-ear element such as the one shown in FIG. 9 so as to comfortably fit a user's ear and effectively focus sound toward the user's eardrum.

Because the cushioned tips shown in FIGS. 10 and 11 are detachable from the at least partially in-ear element shown in FIG. 9, a technique for changing sound characteristics of an auditory device is therefore incorporated in this disclosure, in which a user can remove one type of cushioned tip, such as the open ear tip of FIG. 10, and replace it with the closed ear tip of FIG. 11. The sound processing circuitry adjusts to improve the gain and sound quality of the auditory device without user intervention.

Referring now to FIG. 12, a side view of an at least partially in-ear element 1200 is shown according to a further embodiment of the present disclosure. The at least partially in-ear element includes a receiver 1202 and a microphone 1204. An exemplary description of the operation of these elements has previously been given in conjunction with FIG. 9. An acoustic canal pad 1206 is acoustically connected to the microphone 1204, and resides to one side of the microphone 1204 so that it can be placed against a bony portion of a user's external canal ear. The acoustic canal pad 1206 includes a flexible membrane and a rigid base such that it amplifies and routes acoustic signals to the microphone 1204, operating as a stethoscope-like device for detecting speech-caused vibration of the user's external ear canal.

A cushioned tip 1208 is attached to the end of the at least partially in-ear element 1200, such as those described in conjunction with FIGS. 10 and 11.

A body temperature sensor 1210 is included in the at least partially in-ear element 1200. The body temperature sensor 1210 resides along the at least partially in-ear element 1200 so that it contacts a portion of the ear canal of the user. The body temperature sensor 1210 can be a thermistor or other non-irritating element with temperature-dependent response characteristics. The body temperature sensor 1210 can send an electrical signal to, for example, a behind-the-ear element, which can contain sound processing and health monitoring circuitry programmed to alert the user if the user's temperature rises substantially above 98.6 degrees Fahrenheit, indicating that the user has a fever.

A heart rate monitor 1212 can also be included in the at least partially in-ear element 1200. The heart rate monitor 1212 can be placed against an internal portion of the user's ear canal where the heart rate monitor 1212 can detect the user's heartbeat. The heart rate monitor 1212 can send an electrical signal to, for example, a behind-the-ear element, which can contain sound processing and health monitoring circuitry programmed to alert the user if the user's heart rate is above a certain preselected heart rate, indicating that the user has reached a strenuous level of activity.

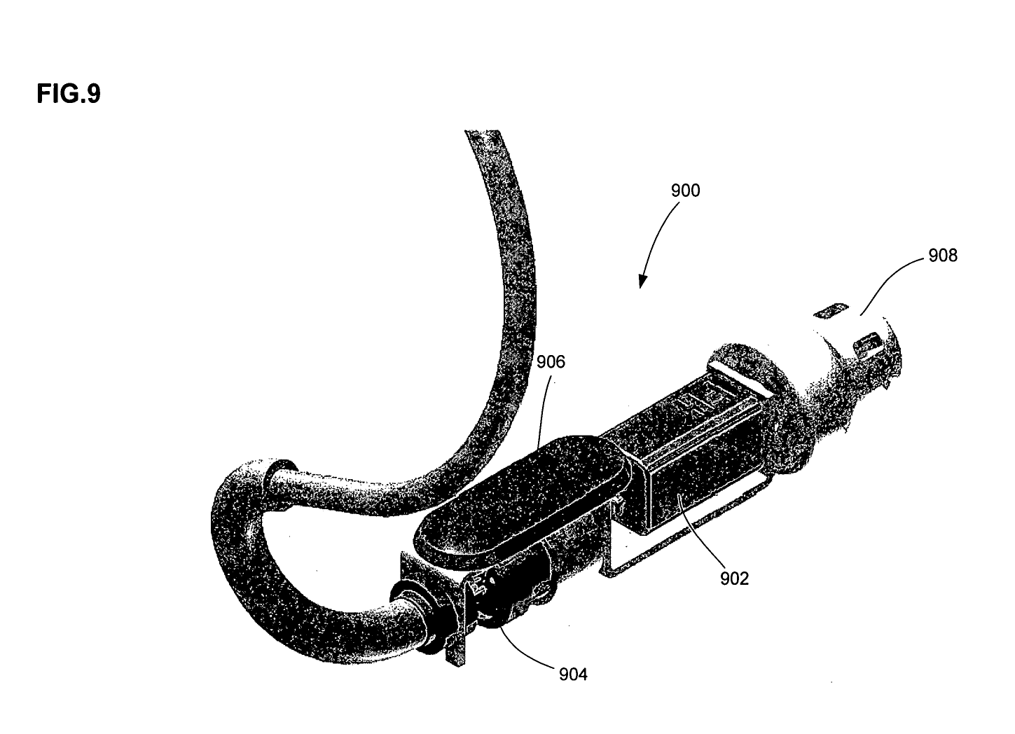

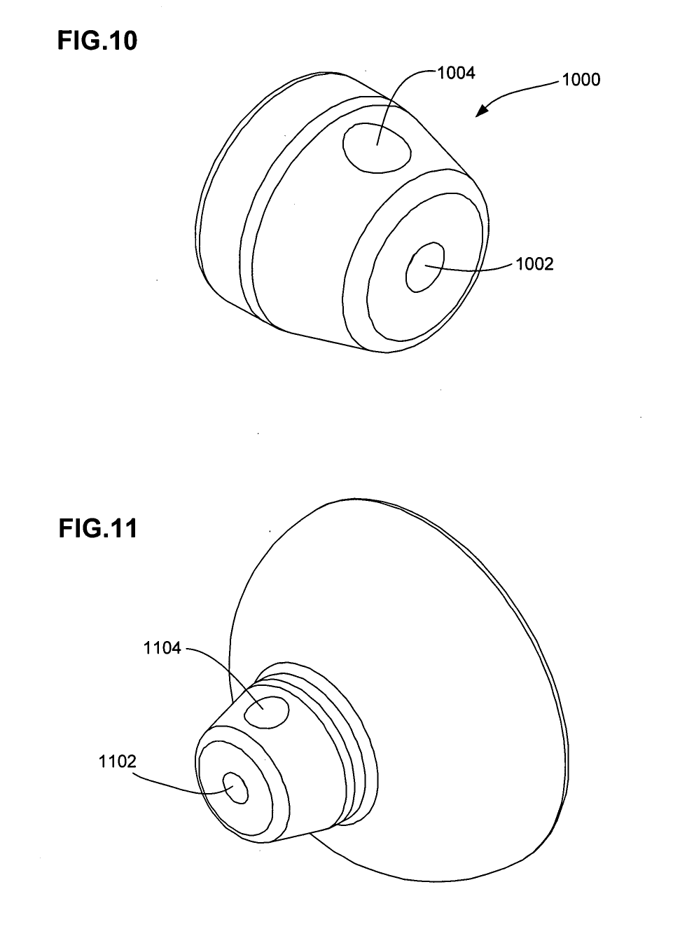

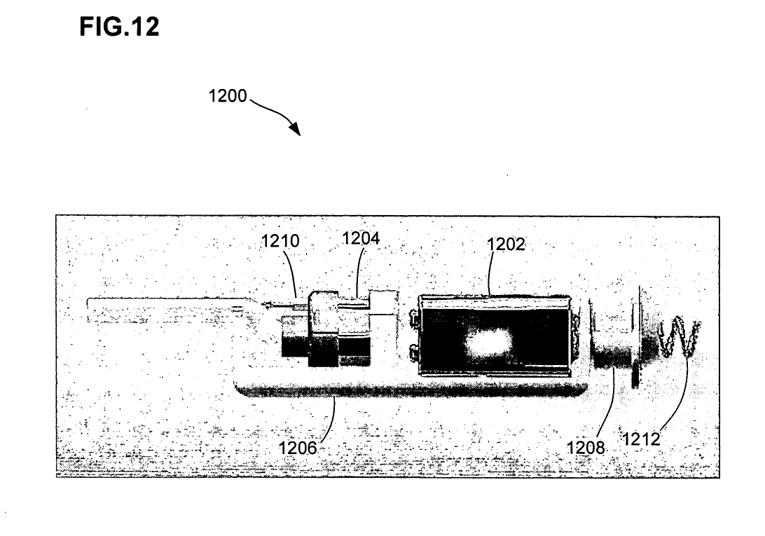

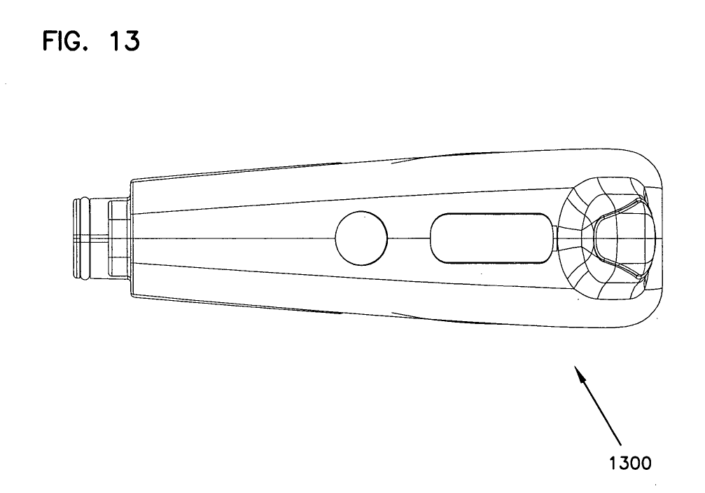

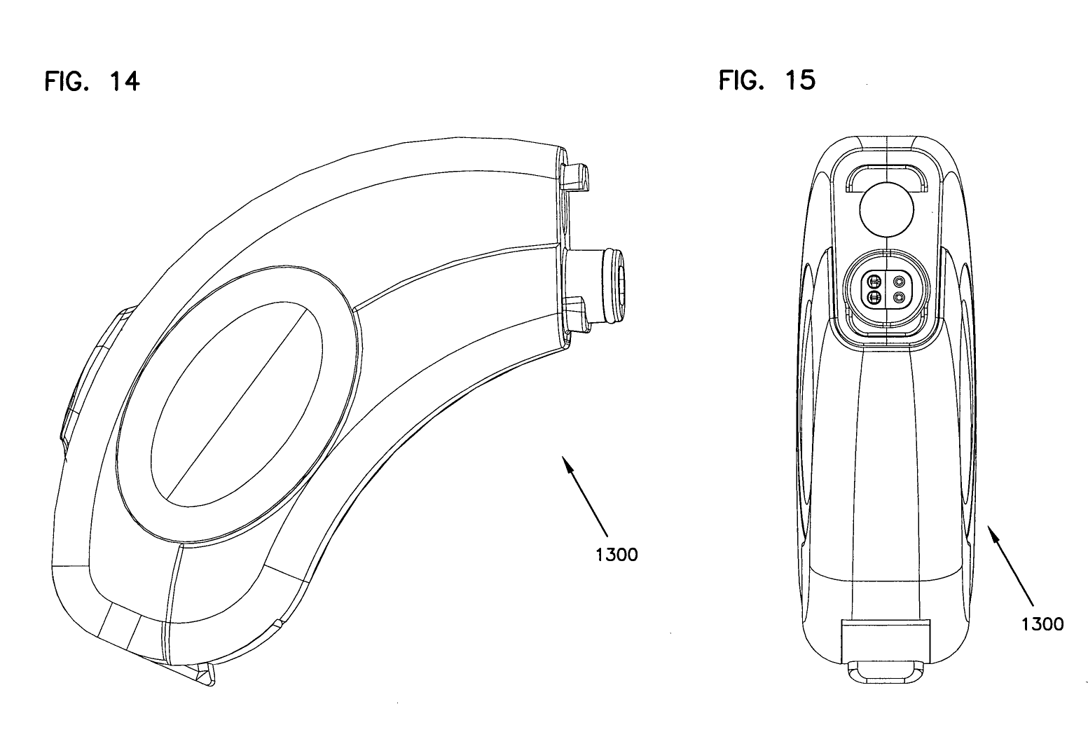

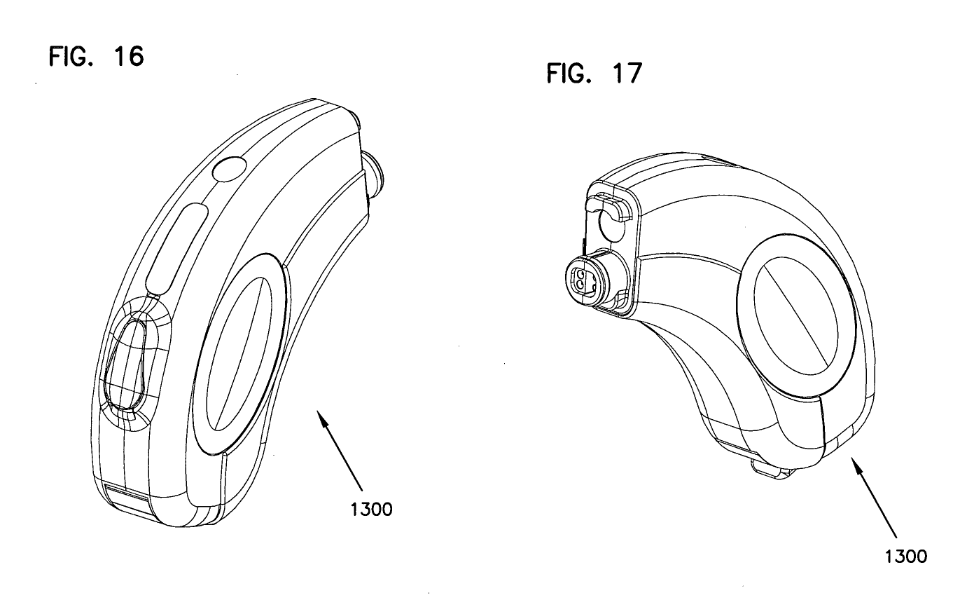

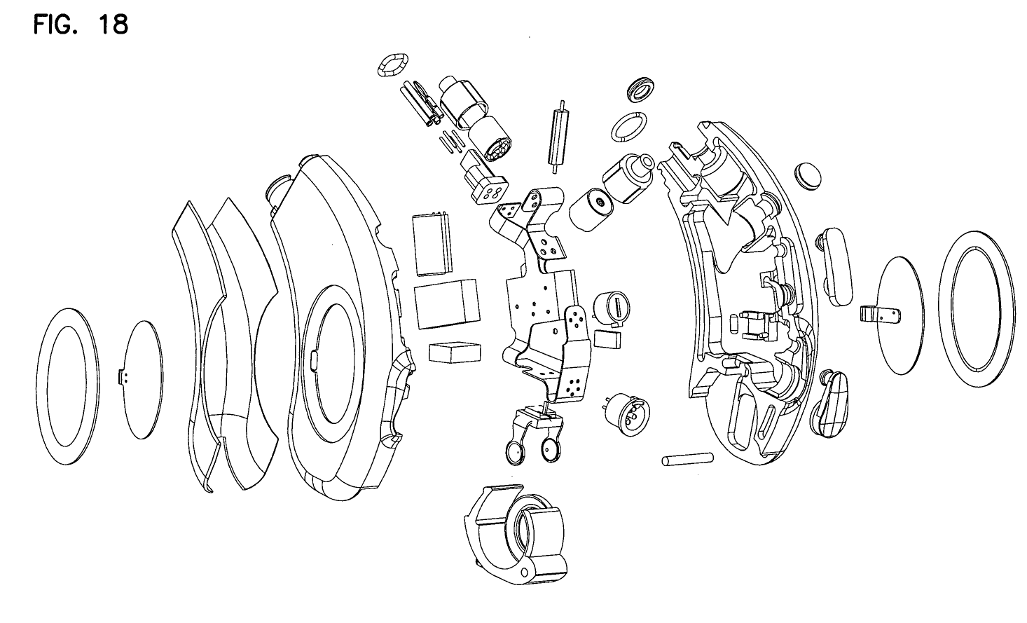

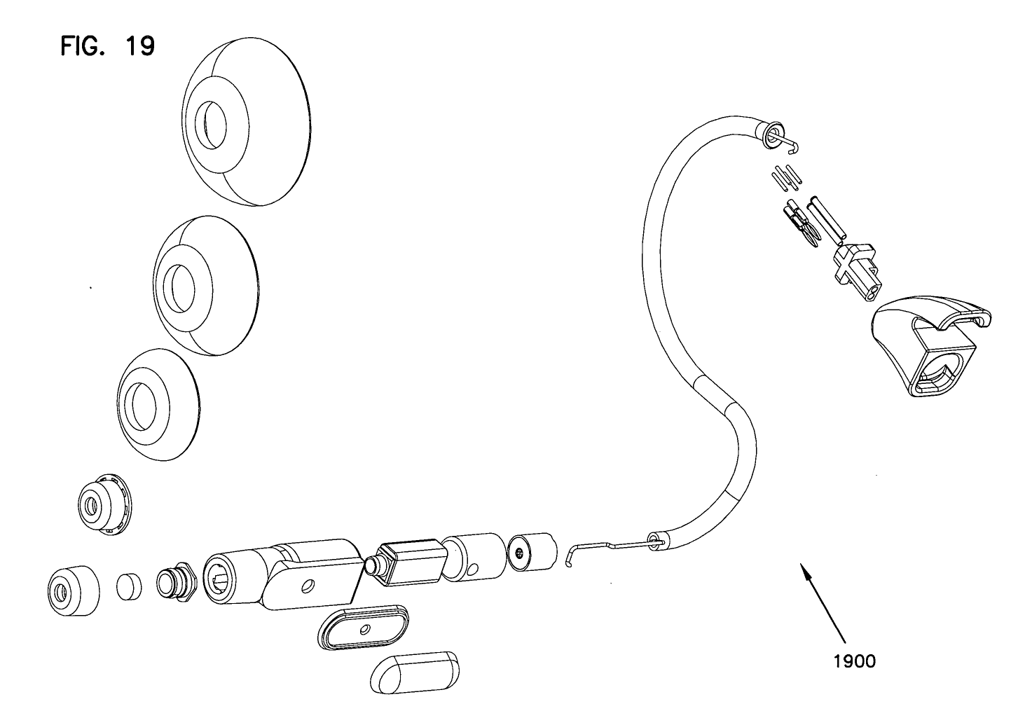

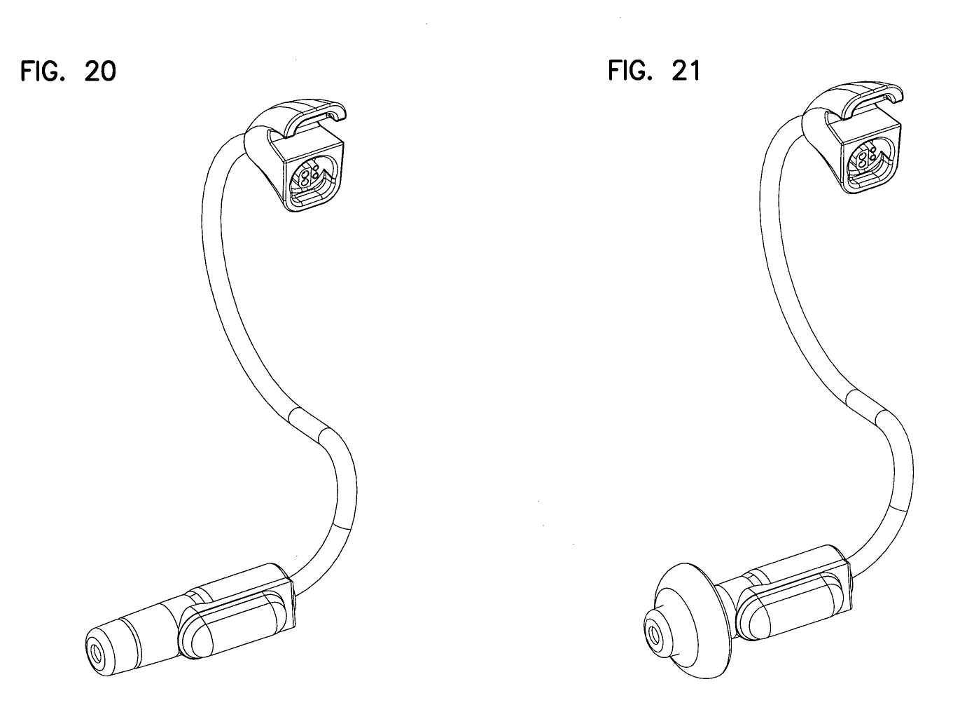

FIGS. 13-17 are views of an auditory device 1300 according to another embodiment of the present disclosure. FIG. 18 is an exploded view of an auditory device 1800 according to another embodiment of the present disclosure. FIG. 19 is an exploded view of an auditory device 1900 that can be connected to, for example, the auditory device 1800 of FIG. 18. FIG. 20 is an example illustration of an auditory device 2000 that can be connected to, for example, the auditory device 1300 of FIGS. 13-17. The auditory device 2000 has an open ear configuration. FIG. 21 is an example illustration of an auditory device 2100 that can be connected to, for example, the auditory device 1300 of FIGS. 13-17. The auditory device 2100 has a closed ear configuration.

The elements disclosed herein, particularly those disclosed in conjunction with the at least partially in-ear element, can be incorporated in either behind-the-ear auditory devices, in-the-ear, canal, mini-canal, half-shell or completely-in-canal auditory devices. Specifically, the usage of a heart rate monitor, configured bone conduction sensor and third microphone, and body temperature sensor can readily be incorporated into both types of devices consistent with the present disclosure and dependent on the preferences of the user.

Consistent with the present disclosure, additional embodiments of the auditory device are also possible, and can include features related to the connective conduit, the behind-the-ear element, or the at least partially in-ear element.

A connective conduit can be incorporated into the auditory device that is retractable into the behind-the-ear element. Additionally, a wide variety of tactile switches can be incorporated into the behind-the-ear element. A radio frequency receiver/transmitter can eliminate the need for a plug as part of the audio input/output port.

Additionally, customized cushioned tips of varying sizes to fit various sized ears can also be included on the at least partially in-ear element. The cushioned tips can be of a variety of configurations. A brace can be included on the at least partially in-ear element to hold the element in place inside the ear. The above specification, examples, and data provide a complete description of the manufacture and use of the invention. Since many embodiments of the invention can be made without departing from the spirit and scope of the invention, the invention resides in the claims hereinafter appended.

1. An auditory device including:
a behind-the-ear element including
(a) an enclosure shaped to fit behind an outer portion of an ear of a user, the shell having a first side and a second side substantially parallel to each other, and the first side facing the outer portion of the ear and the second side facing a head of the user;
(b) sound processing circuitry within the enclosure; and
(c) an ear cushion switch located on the first side of the shell and operatively connected to the sound processing circuitry; and
an at least partially in-ear element operatively connected to the behind-the-ear element and comprising a receiver and a cushioned tip.

2. The auditory device of claim 1 wherein the ear cushion switch includes a pushbutton switch.

3. The auditory device of claim 1 wherein the ear cushion switch includes a flexible membrane covering an electrical or electromechanical switching device.

4. The auditory device of claim 1 wherein the behind-the-ear element further comprises a second ear cushion switch located on the second side of the shell and facing the head of the user.

5. The auditory device of claim 1 wherein the behind-the-ear element is substantially waterproof.

6. The auditory device of claim 1 wherein the at least partially in-ear element further comprises a microphone.

7. The auditory device of claim 6 wherein the at least partially in-ear element further comprises an acoustic canal pad operatively connected to the microphone.

8. The auditory device of claim 1 wherein the at least partially in-ear element further comprises a body temperature sensor.

9. The auditory device of claim 1 wherein the at least partially in-ear element further comprises a heart rate monitor.

10. The auditory device of claim 1 wherein the behind-the-ear element further comprises a telecoil.

11. The auditory device of claim 1 wherein the behind-the-ear element further comprises two microphones.

12. The auditory device of claim 11 wherein the behind-the-ear element further comprises one or more dampening elements partially surrounding the two microphones.

13. The auditory device of claim 1 wherein the behind-the-ear element further comprises an audio input/output port.

14. The auditory device of claim 13 wherein the audio input/output port is also a data input port.

15. The auditory device of claim 13 wherein the audio input/output port is operatively connected to the sound processing circuitry.

16. The auditory device of claim 13 wherein the audio input/output port is an RF communication port.

17. The auditory device of claim 1 wherein the sound processing circuitry is programmable.

18. The auditory device of claim 1 wherein the at least partially in-ear element is physically connected to the behind-the-ear element by a molded, flexible conduit.

19. The auditory device of claim 1 wherein the at least partially in-ear element is electrically connected to the behind-the-ear element by at least four conductive wires.

20. The auditory device of claim 1 wherein the cushioned tip is detachable.

21. The auditory device of claim 20 wherein the cushioned tip forms an open-ear configuration.

22. The auditory device of claim 20 wherein the cushioned tip forms a closed-ear configuration.

23. The auditory device of claim 1 wherein the sound processing circuitry contains both open and closed ear algorithms.

24. A configurable auditory device comprising:
a behind-the-ear element including
(a) a shell shaped to fit behind an outer portion of an ear of a user, the shell having a first side and a second side substantially parallel to each other, and the first side facing the outer portion of the ear and the second side facing a head of the user;
(b) sound processing circuitry within the shell; and
an at least partially in-ear element operatively connected to the behind-the-ear element and comprising a receiver, a first detachable cushioned tip having a first auditory characteristic, and a second detachable cushioned tip having a second auditory characteristic.

25. The configurable auditory device of claim 24 wherein the first detachable cushioned tip is an open ear detachable cushioned tip.

26. The configurable auditory device of claim 24 wherein the second detachable cushioned tip is a closed ear detachable cushioned tip.

27. The configurable auditory device of claim 24 wherein the sound processing circuitry contains both open and closed ear algorithms.

28. The configurable auditory device of claim 24 wherein the at least partially in-ear element further comprises a microphone.

29. The configurable auditory device of claim 24 wherein the at least partially in-ear element further comprises an acoustic canal pad operatively connected to the microphone.

30. The configurable auditory device of claim 24 wherein the behind-the-ear element further comprises an ear cushion switch.

31. The configurable auditory device of claim 24 wherein the ear cushion switch is located on the first side of the shell and operatively connected to the sound processing circuitry.

32. The configurable auditory device of claim 31 wherein the ear cushion switch includes a flexible membrane covering an electrical or electromechanical switching device.

33. The configurable auditory device of claim 31 wherein the behind-the-ear element further comprises a second ear cushion switch located on the second side of the shell and facing the head of the user.

34. The configurable auditory device of claim 24 wherein the behind-the-ear element is substantially waterproof.

35. The configurable auditory device of claim 24 wherein the at least partially in-ear element is physically connected to the behind-the-ear element by a molded, flexible conduit.

36. The configurable auditory device of claim 24 wherein the at least partially in-ear element is electrically connected to the behind-the-ear element by at least four conductive wires.

37. The configurable auditory device of claim 24 wherein the at least partially in-ear element further comprises a microphone.

38. The configurable auditory device of claim 37 wherein the at least partially in-ear element further comprises an acoustic canal pad operatively connected to the microphone.

39. The configurable auditory device of claim 24 wherein the at least partially in-ear element further comprises a heart rate monitor.

40. The configurable auditory device of claim 24 wherein the at least partially in-ear element further comprises a temperature sensor.

41. A method of changing a mode of an auditory device comprising:
placing an auditory device having an ear cushion switch operatively connected to sound processing circuitry behind an ear, the ear cushion switch facing the ear; and
pressing the ear to activate the ear cushion switch.

42. The method of claim 41 wherein the auditory device is a behind-the-ear hearing aid.

43. The method of claim 41 wherein pressing the ear to activate the ear cushion switch changes a mode of the auditory device.

44. The method of claim 41 wherein the auditory device has at least two modes.

45. The method of claim 41 wherein the auditory device has an open ear configuration mode and a closed ear configuration mode.

46. A method of changing a mode of an auditory device comprising:
detaching a first cushioned tip having a first configuration from an at least partially in-ear element of an auditory device; and
attaching a second cushioned tip having a second configuration to the at least partially in-ear element.

47. The method of claim 46 wherein the first configuration and the second configuration provide different acoustical characteristics.

48. The method of claim 46 wherein the first configuration is a closed ear configuration.

49. The method of claim 46 wherein the first configuration is an open ear configuration.

50. The method of claim 46 wherein the second configuration is a closed ear configuration.

51. The method of claim 46 wherein the second configuration is an open ear configuration.

52. An at least partially in-ear hearing aid comprising:
(a) sound processing circuitry within a shell;
(b) a receiver operatively connected to the sound processing circuitry, the receiver residing within an at least partially in-ear portion of the at least partially in-ear hearing aid and designed to generate audio signals received from the sound processing circuitry;
(c) a body temperature sensor operatively connected to the sound processing circuitry, wherein the temperature sensor resides within the at least partially in-ear portion.

53. The at least partially in-ear hearing aid of claim 52, further comprising a heart rate monitor residing within the at least partially in-ear element.

54. The at least partially in-ear hearing aid of claim 52, further comprising a microphone within the at least partially in-ear element.

55. The at least partially in-ear hearing aid of claim 52 wherein the sound processing circuitry receives electrical signals from three microphones.

56. The at least partially in-ear hearing aid of claim 52 wherein the at least partially in-ear hearing aid is a completely-in-canal hearing aid.

57. The at least partially in-ear hearing aid of claim 52 wherein the at least partially in-ear hearing aid is a behind-the-ear hearing aid.
